(19) United States
(12) Patent Application Publication
(10) Pub. No.: US 2025/0202531 A1
(43) Pub. Date: Jun. 19, 2025

(54) DETECTING PASSIVE DEVICES PROXIMATE TO A READER DEVICE

(71) Applicant: QUALCOMM INCORPORATED, San Diego, CA (US)

(72) Inventors: Ahmed ELSHAFIE, San Diego, CA (US); Zhikun WU, Beijing (CN); Huilin XU, Temecula, CA (US); Seyedkianoush HOSSEINI, San Diego, CA (US); Yuchul KIM, San Diego, CA (US); Wei YANG, San Diego, CA (US)

(21) Appl. No.: 18/851,665

(22) PCT Filed: Jun. 2, 2022
(86) PCT No.: PCT/CN2022/096780

§ 371 Date: Sep. 26, 2024

(51) Int. Cl. H04B 5/45; G06K 7/10; H04B 5/79; H04L 5/00; H04W 72/51; H04W 76/40

(52) U.S. Cl. CPC H04B 5/45; G06K 7/10009; H04B 5/79; H04L 5/0048; H04W 72/51; H04W 76/40

(57) ABSTRACT

Methods, systems, and devices for wireless communication are described. A user equipment (UE) may broadcast a message initiating a passive device identification procedure for one or more passive devices located proximate to the UE. The UE may transmit one or more reference signals based at least in part on the message and according to the passive device identification procedure. The UE may receive a set of one or more response signals from at least a portion of the one or more passive devices based at least in part on at least one of the one or more reference signals. The UE may communicate with at least the portion of the one or more passive devices according to scheduling that is based at least in part on the set of one or more response signals.

### CROSS REFERENCE

The present Application is a 371 national stage filing of International PCT Application No. PCT/CN2022/096780 by Elshafie et al. entitled “DETECTING PASSIVE DEVICES PROXIMATE TO A READER DEVICE,” filed Jun. 2, 2022, which is assigned to the assignee hereof, and which is expressly incorporated by reference in its entirety herein.

### TECHNICAL FIELD

The following relates to wireless communication, including detecting passive devices proximate to a reader device.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support detecting passive devices proximate to a reader device. For example, the described techniques provide for a user equipment (UE) (e.g., a UE performing cellular communications and/or sidelink communications) to identify, detect, or otherwise quantify the numerical quantity of passive devices proximate to the UE within a cellular and/or sidelink based communications network. Examples of such passive devices include traditional classic devices (e.g., similar to passive and/or semi-active radio frequency identifier (RFID) devices), Internet-of-Things (IoT) devices, or any other device supporting backscattering-based communications. For example, the UE may transmit or otherwise provide (e.g., in a broadcast transmission) a message initiating a passive device identification procedure for passive device(s) proximate to the UE. The UE may then transmit or otherwise provide reference signal(s) based on the message and according to the passive device identification procedure. For example, the UE may transmit the reference signal(s) on resource(s) associated with the passive device(s). The UE may then receive response signal(s) from none, one, some, or all of the passive devices proximate to the UE based on the reference signals. The UE may use the response signal(s) received from the passive device(s) to schedule communications. For example, the UE may determine how many passive devices are located proximate to it, determine the identify of some or all of the passive devices providing response signals, or otherwise quantify the proximate passive devices. Based on the understanding of the passive devices located proximate to the UE, the UE may (alone or in combination with a network entity) schedule or otherwise allocate appropriate resources to support communications with the proximate passive devices.

A method for wireless communication at a UE is described. The method may include broadcasting a message initiating a passive device identification procedure for one or more passive devices located proximate to the UE, transmitting one or more reference signals based on the message and according to the passive device identification procedure, receiving a set of one or more response signals from at least a portion of the one or more passive devices based on at least one of the one or more reference signals, and communicating with at least the portion of the one or more passive devices according to scheduling that is based on the set of one or more response signals.

An apparatus for wireless communication at a UE is described. The apparatus may include a processor, memory coupled with the processor, and instructions stored in the memory. The instructions may be executable by the processor to cause the apparatus to broadcast a message initiating a passive device identification procedure for one or more passive devices located proximate to the UE, transmit one or more reference signals based on the message and according to the passive device identification procedure, receive a set of one or more response signals from at least a portion of the one or more passive devices based on at least one of the one or more reference signals, and communicate with at least the portion of the one or more passive devices according to scheduling that is based on the set of one or more response signals.

Another apparatus for wireless communication at a UE is described. The apparatus may include means for broadcasting a message initiating a passive device identification procedure for one or more passive devices located proximate to the UE, means for transmitting one or more reference signals based on the message and according to the passive device identification procedure, means for receiving a set of one or more response signals from at least a portion of the one or more passive devices based on at least one of the one or more reference signals, and means for communicating with at least the portion of the one or more passive devices according to scheduling that is based on the set of one or more response signals.

A non-transitory computer-readable medium storing code for wireless communication at a UE is described. The code may include instructions executable by a processor to broadcast a message initiating a passive device identification procedure for one or more passive devices located proximate to the UE, transmit one or more reference signals based on the message and according to the passive device identification procedure, receive a set of one or more response signals from at least a portion of the one or more passive devices based on at least one of the one or more reference signals, and communicate with at least the portion of the one or more passive devices according to scheduling that is based on the set of one or more response signals.

In some examples of the method, apparatuses, and non-transitory computer-readable medium described herein, broadcasting the message may include operations, features, means, or instructions for selecting one or more resources associated with the one or more passive devices, where the message may be broadcast on the one or more resources.

In some examples of the method, apparatuses, and non-transitory computer-readable medium described herein, broadcasting the message may include operations, features, means, or instructions for requesting, via the message, a response signal from one or more of: passive devices of the one or more passive devices with new data to communicate, passive devices of the one or more passive devices with no new data to communicate, or both.

In some examples of the method, apparatuses, and non-transitory computer-readable medium described herein, broadcasting the message may include operations, features, means, or instructions for including in the message an identifier associated with each of the one or more passive devices, where the set of one or more response signals may be received based on the identifier indicated in the message.

Some examples of the method, apparatuses, and non-transitory computer-readable medium described herein may further include operations, features, means, or instructions for identifying a numerical quantity of passive devices located proximate to the UE based on a number of response signals in the set of one or more response signals.

Some examples of the method, apparatuses, and non-transitory computer-readable medium described herein may further include operations, features, means, or instructions for transmitting a signal to a network entity indicating the numerical quantity of passive devices located proximate to the UE.

Some examples of the method, apparatuses, and non-transitory computer-readable medium described herein may further include operations, features, means, or instructions for receiving a control signal scheduling a resource to use for the communicating, where the resource may be based on the indication of the numerical quantity.

Some examples of the method, apparatuses, and non-transitory computer-readable medium described herein may further include operations, features, means, or instructions for selecting, based on the numerical quantity, resources from a set of available resources to use for the communicating and scheduling the communications with at least the portion of the one or more passive devices using the resources.

Some examples of the method, apparatuses, and non-transitory computer-readable medium described herein may further include operations, features, means, or instructions for identifying, for each response signal in the set of one or more response signals, a time delay for the response signal and identifying each passive device in at least the portion of the one or more passive devices based on the time delay of the response signal.

Some examples of the method, apparatuses, and non-transitory computer-readable medium described herein may further include operations, features, means, or instructions for identifying, for each response signal in the set of one or more response signals, a sequence indicated in the response signal and identifying each passive device in at least the portion of the one or more passive devices based on the sequence indicated in the response signal.

Some examples of the method, apparatuses, and non-transitory computer-readable medium described herein may further include operations, features, means, or instructions for identifying, for each response signal in the set of one or more response signals, a backscattering pulse repetition interval time (TPRI) indicated in the response signal and identifying each passive device in at least the portion of the one or more passive devices based on the TPRI indicated in the response signal.

Some examples of the method, apparatuses, and non-transitory computer-readable medium described herein may further include operations, features, means, or instructions for identifying each passive device in at least the portion of the one or more passive devices based on a frequency shift of each response signal in the set of one or more response signals.

Some examples of the method, apparatuses, and non-transitory computer-readable medium described herein may further include operations, features, means, or instructions for identifying each passive device in at least the portion of the one or more passive devices based on a modulation rate of each response signal in the set of one or more response signals.

Some examples of the method, apparatuses, and non-transitory computer-readable medium described herein may further include operations, features, means, or instructions for identifying each passive device in at least the portion of the one or more passive devices based on a power domain randomization of each response signal in the set of one or more response signals.

In some examples of the method, apparatuses, and non-transitory computer-readable medium described herein, the one or more passive devices include at least one of a proximate UE, an IoT device, a passive RFID device, a semi-active RFID device, a device supporting backscattering-based communications, or a combination thereof.

A method for wireless communication at a passive device is described. The method may include receiving a message initiating a passive device identification procedure for one or more passive devices located proximate to a UE, receiving at least one reference signal of a set of one or more reference signals based on the message and according to the passive device identification procedure, transmitting a response signal to the UE based on the at least one reference signal, and communicating with the UE according to scheduling that is based on the response signal.

An apparatus for wireless communication at a passive device is described. The apparatus may include a processor, memory coupled with the processor, and instructions stored in the memory. The instructions may be executable by the processor to cause the apparatus to receive a message initiating a passive device identification procedure for one or more passive devices located proximate to a UE, receive at least one reference signal of a set of one or more reference signals based on the message and according to the passive device identification procedure, transmit a response signal to the UE based on the at least one reference signal, and communicate with the UE according to scheduling that is based on the response signal.

Another apparatus for wireless communication at a passive device is described. The apparatus may include means for receiving a message initiating a passive device identification procedure for one or more passive devices located proximate to a UE, means for receiving at least one reference signal of a set of one or more reference signals based on the message and according to the passive device identification procedure, means for transmitting a response signal to the UE based on the at least one reference signal, and means for communicating with the UE according to scheduling that is based on the response signal.

A non-transitory computer-readable medium storing code for wireless communication at a passive device is described. The code may include instructions executable by a processor to receive a message initiating a passive device identification procedure for one or more passive devices located proximate to a UE, receive at least one reference signal of a set of one or more reference signals based on the message and according to the passive device identification procedure, transmit a response signal to the UE based on the at least one reference signal, and communicate with the UE according to scheduling that is based on the response signal.

Some examples of the method, apparatuses, and non-transitory computer-readable medium described herein may further include operations, features, means, or instructions for determining that the message was received on a resource associated with the passive device.

Some examples of the method, apparatuses, and non-transitory computer-readable medium described herein may further include operations, features, means, or instructions for determining that the message requests a response signal from one or more of: one or more passive devices with new data to communication, one or more passive devices with no new data to communicate, or both.

Some examples of the method, apparatuses, and non-transitory computer-readable medium described herein may further include operations, features, means, or instructions for delaying transmitting the response signal according to a time delay associated with the passive device.

Some examples of the method, apparatuses, and non-transitory computer-readable medium described herein may further include operations, features, means, or instructions for including a sequence associated with the passive device in the response signal.

Some examples of the method, apparatuses, and non-transitory computer-readable medium described herein may further include operations, features, means, or instructions for including a TPRI associated with the passive device in the response signal.

Some examples of the method, apparatuses, and non-transitory computer-readable medium described herein may further include operations, features, means, or instructions for applying a frequency shift associated with the passive device for the response signal.

Some examples of the method, apparatuses, and non-transitory computer-readable medium described herein may further include operations, features, means, or instructions for applying a modulation rate associated with the passive device for the response signal.

Some examples of the method, apparatuses, and non-transitory computer-readable medium described herein may further include operations, features, means, or instructions for applying a power domain randomization associated with the passive device for the response signal.

### BRIEF DESCRIPTION OF THE DRAWINGS

FIG. 1 illustrates an example of a wireless communications system that supports detecting passive devices proximate to a reader device in accordance with one or more aspects of the present disclosure.

FIG. 2 illustrates an example of a wireless communication system that supports detecting passive devices proximate to a reader device in accordance with one or more aspects of the present disclosure.

FIG. 3 illustrates an example of a signal configuration that supports detecting passive devices proximate to a reader device in accordance with one or more aspects of the present disclosure.

FIG. 4 illustrates an example of a signal configuration that supports detecting passive devices proximate to a reader device in accordance with one or more aspects of the present disclosure.

FIG. 5 illustrates an example of a method that supports detecting passive devices proximate to a reader device in accordance with one or more aspects of the present disclosure.

FIGS. 6 and 7 show block diagrams of devices that support detecting passive devices proximate to a reader device in accordance with one or more aspects of the present disclosure.

FIG. 8 shows a block diagram of a communications manager that supports detecting passive devices proximate to a reader device in accordance with one or more aspects of the present disclosure.

FIG. 9 shows a diagram of a system including a device that supports detecting passive devices proximate to a reader device in accordance with one or more aspects of the present disclosure.

FIGS. 10 through 14 show flowcharts illustrating methods that support detecting passive devices proximate to a reader device in accordance with one or more aspects of the present disclosure.

### DETAILED DESCRIPTION

Some wireless devices may be considered passive devices, such as devices using backscattering communication technologies. For example, radio frequency identification (RFID) systems are widely used with passive devices for a variety of purposes. Passive devices generally utilize a smaller form factor with reduced cost and complexity. Such devices generally rely on the backscattering communication techniques to support communicating small amounts of data between the passive RFID devices and a reader device. However, such RFID systems are generally limited to operations in a radio frequency spectrum band that is different from the band(s) used for cellular and/or sidelink communication, such as is used in a wireless communication system. Moreover, RFID communications are simplistic in that there is little or no coordination of resources, do not support different configurations or parameters for the backscattering based communications, or other related features. This may result in limited or no support for passive device communications within a wireless communication system (e.g., cellular/Uu interface based communications and/or sidelink/PC5 interface based communications.

Accordingly, aspects of the described techniques relate to improved methods, systems, devices, and apparatuses that support detecting passive devices proximate to a reader device. For example, the described techniques provide for a user equipment (UE) (e.g., a UE performing cellular communications and/or sidelink communications) to identify, detect, or otherwise quantify the numerical quantity of passive devices proximate to the UE within a cellular and/or sidelink based communications network. Examples of such passive devices include traditional classic devices (e.g., similar to passive and/or semi-active RFID devices), Internet-of-Things (IoT) devices, or any other device supporting backscattering-based communications. For example, the UE may transmit or otherwise provide (e.g., in a broadcast transmission) a message initiating a passive device identification procedure for passive device(s) proximate to the UE. The UE may then transmit or otherwise provide reference signal(s) based on the message and according to the passive device identification procedure. For example, the UE may transmit the reference signal(s) on resource(s) associated with the passive device(s). The UE may then receive response signal(s) from none, one, some, or all of the passive devices proximate to the UE based on the reference signals. The UE may use the response signal(s) received from the passive device(s) to schedule communications. For example, the UE may determine how many passive devices are located proximate to it, determine the identify of some or all of the passive devices providing response signals, or otherwise quantify aspects of the proximate passive devices. Based on the understanding of the passive devices located proximate to the UE, the UE may (alone or in combination with a network entity) schedule or otherwise allocate appropriate resources to support communications with the proximate passive devices.

Aspects of the disclosure are initially described in the context of wireless communications systems. Aspects of the disclosure are further illustrated by and described with reference to apparatus diagrams, system diagrams, and flowcharts that relate to detecting passive devices proximate to a reader device.

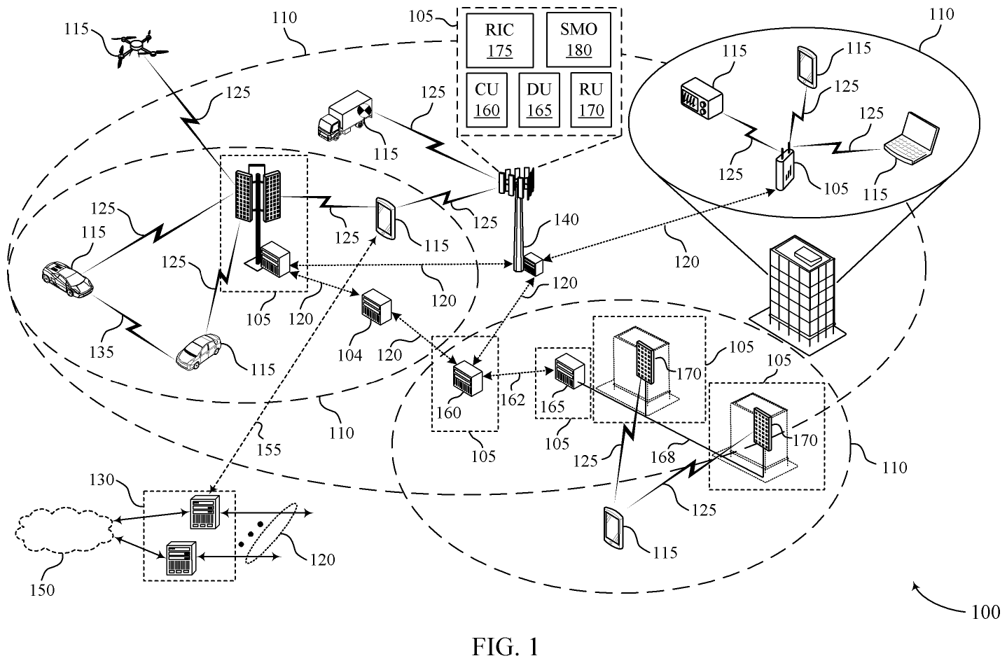

FIG. 1 illustrates an example of a wireless communications system 100 that supports detecting passive devices proximate to a reader device in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node. Components within a wireless communication system may be coupled (for example, operatively, communicatively, functionally, electronically, or electrically) to each other.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support detecting passive devices proximate to a reader device as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting.” “receiving.” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrow band IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrow band communications), or a combination of these techniques. For example, some UEs 115 may be configured for operation using a narrow band protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHZ, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

A UE 115 (e.g., a reader device) may broadcast a message initiating a passive device identification procedure for one or more passive devices located proximate to the UE 115. The UE 115 may transmit one or more reference signals based at least in part on the message and according to the passive device identification procedure. The UE 115 may receive a set of one or more response signals from at least a portion of the one or more passive devices based at least in part on at least one of the one or more reference signals. The UE 115 may communicate with at least the portion of the one or more passive devices according to scheduling that is based at least in part on the set of one or more response signals.

A UE 115 (e.g., a UE 115, such as an IoT device, configured as or otherwise supporting backscattering-based communications) may receive a message initiating a passive device identification procedure for one or more passive devices located proximate to a UE 115. The UE 115 may receive at least one reference signal of a set of one or more reference signals based at least in part on the message and according to the passive device identification procedure. The UE 115 may transmit a response signal to the UE 115 (e.g., a reader device) based at least in part on the at least one reference signal. The UE 115 may communicate with the UE 115 according to scheduling that is based at least in part on the response signal.

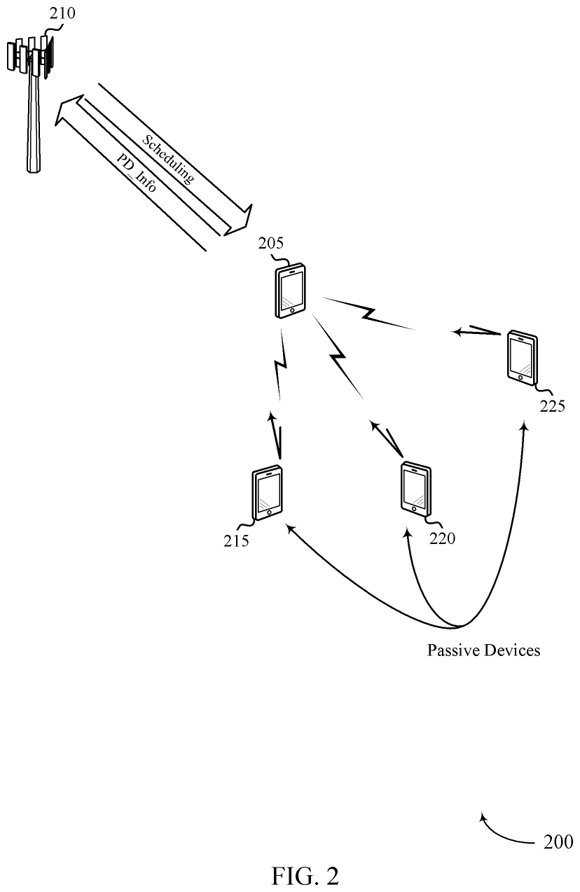

FIG. 2 illustrates an example of a wireless communication system 200 that supports detecting passive devices proximate to a reader device in accordance with one or more aspects of the present disclosure. Wireless communication system 200 may implement aspects of wireless communication system 100. Wireless communication system 200 may include UE 205, network entity 210, UE 215, UE 220, or UE 225, which may be examples of the corresponding devices described herein.

For example, UE 215, UE 220, or UE 225 may be examples of passive devices, with UE 205 being an example of a reader device, as discussed herein. Generally, references to passive devices generally include any device configured to or otherwise supporting backscattering-based communication techniques, or any other passive communication technologies. For example, a passive device may refer to another UE that is proximate to UE 205, such as UE 215, UE 220, or UE 225, that supports backscattering-based communications (e.g., RFID style communications). In another example, a passive device may refer to an IoT device, such as a passive IoT device (e.g., with limited circuitry/functionality) or a semi-active IoT device (e.g., with more advanced circuitry/functionality). In some examples, passive devices may include any device with limited capabilities (e.g., limited active circuitry, little or no on-board power source, limited capability, or limited functionality), any device that communicates small amounts of data regularly or as-needed (e.g., MTC type devices), or any device that is able to communicate with a reader device using such backscattering-based communications (e.g., similar to RFID-based communications). In some examples, a passive device may be an example of an advanced device (e.g., a UE) fully capable of performing wireless communications within a cellular or sidelink wireless network, but may also support such backscattering-based communications.

A reader device (such as UE 205) may generally refer to any device capable of communicating with, or otherwise associated with, a passive device using backscattering-based communications. A reader device may be implemented at a single device (e.g., the reader device is both the device transmitting messages or other signals to the passive devices and receiving (e.g., reads) response signals from the passive devices) or spread across multiple devices (e.g., separate transmitting and receiving devices). The reader device may be a stand-alone device or may the functionality of the reader device may be a part of a complex/multi-function device (e.g., such as a stand-alone UE).

Reader/passive devices currently rely on RFID communication techniques in the ISM radio frequency spectrum band. Such RFID communication techniques are generally decentralized in that the communications are passive in nature with the passive devices only communicating in the presence of the reader device. That is, there is no coordination or management of communication resources, interference management between devices, or related functions, between the reader device and the passive device in support of the passive RFID communications. Broadly speaking, the passive device simply performs the wireless communications with a reader device when the devices are within a range of each other.

As one non-limiting example, backscattering-based communications may include information modulation methods for such backscatter communications using amplitude shift keying (ASK). ASK generally includes the passive device switching, activating, or otherwise initiating a reflection of a reference signal to transmit or otherwise indicate a one (“1”) and switching, deactivating, or otherwise stopping the reflection of the reference signal to transmit or otherwise indicate a zero (“0”). That is, a reader device generally transmits a radio wave (such as a continuous wave (CW)) that can be denoted as x(n). The information bits of the backscattering device (e.g., the passive device) can be defined as s(n)∈{0,1}. The signal received at the UE (e.g., the response signal received at the reader device) may then be defined as y(n)=(h_{D1D2}(n)+σ_{f}h_{D1T}(n)h_{TD2}(n)s(n))x(n)+noise. When s(0), the reflection is switched off at the backscattering device, so the UE only receives the direct link signal, e.g., y(n)=h_{D1D2}(n)x(n)+noise. When s(1), the reflection is switched on at the backscattering device, so the UE only receives the superposition of both the direct link signal and the backscatter link signal, e.g., y(n)=(h_{D1D2}(n)+σ_{f}h_{D1T}(n)h_{TD2}(n)s(n))x(n)+noise, where of denotes the reflection coefficient. To receive the transmitted information bit from the backscattering device, the UE may first decode x(n) based on the known h_{D1D2}(n) by treating the backscatter link signal as interference. Then, the UE may detect the existence of the term σ_{f}h_{D1T}(n)h_{TD2}(n)s (n)x(n) by subtracting h_{D1D2}(n)x(n) from y(n).

While such RFID based backscattering communication techniques support some passive-based communications, such techniques are limiting. That is, advanced wireless communication systems (such as wireless communication system 200) may support a larger number of devices supporting passive-based communication techniques. For example, such passive devices may utilize backscattering or other passive-based communication techniques while operating within a wireless communication system. That is, passive devices, such as UE 215, UE 220, or UE 225, may utilize backscattering or other passive-based communication techniques within a cellular-based (e.g., Uu interface) or a sidelink-based (e.g., PC5 interface) wireless communication system. Such cellular/sidelink communication systems may utilize coordinated resources, scheduling, interference management, security, and many other features/functions supporting wireless communications between devices.

As one non-limiting example, a UE 205 may be a conventional cell phone or tablet carried by a user and relied upon as the primary communications device. The user may also carry or otherwise be associated with a number of passive devices, such as passive or semi-active IoT devices, such as sensors, switches, or other IoT/passive type device features. Such sensors, switches, and so forth may generally provide information (e.g., small amounts of data) to UE 205 to utilize in support of various functions (e.g., such as walking asymmetry, standing time, and so forth). To improve and protect such passive communications, it may be beneficial for UE 205 to be able to detect, identify, or otherwise quantify the passive devices located proximate to UE 205 (e.g., passive devices carried by the user) in order to improve wireless communications. For example, UE 205, alone or in combination with network entity 210, may schedule communications, allocate resources, or otherwise utilize the information regarding the number, type, or which passive devices are nearby. For example, UE 205, alone or in combination with network entity 210, may improve interference management to improve reliability of such communications. In some examples, UE 205 may autonomously initiate a passive device identification procedure or network entity 210 may initiate the procedure at UE 205 (e.g., by transmitting or otherwise providing a signal instructing UE 205 to initiate the procedure).

Accordingly, aspects of the techniques described herein include UE 205, alone or in combination with network entity 210, using a passive device identification procedure for passive devices located proximate (e.g., within a threshold geographic range) to UE 205. Broadly, the passive device identification procedure may generally enable UE 205 and, in some examples, network entity 210 to detect or otherwise determine which (e.g., how many, what type(s), or identification information) for the passive devices within the threshold range of UE 205. In the non-limiting example illustrated in FIG. 2, UE 215, UE 220, and UE 225 may be considered examples of such passive devices.

This may include UE 205 transmitting or otherwise providing for output signaling initiating the passive device identification procedure. For example, UE 205 may transmit or otherwise provide for broadcast one or more messages initiating the passive device identification procedure for one, some or all of the passive devices proximate to UE 205. That is, UE 205 or network entity 210 may transmit, indicate, or otherwise provide for output to passive devices (e.g., passive IoT devices/tags), such as in a broadcast manner, an indication to start the passive device identification procedure (e.g., a tag counting/identifying process). The message(s) may be group-based or broadcast-based transmissions to any/all passive devices within a threshold range of UE 205.

In some examples, this may include UE 205 or network entity 210 identifying or otherwise selecting one or more resources associated with passive devices and using the resource(s) for broadcasting the message initiating the passive device identification procedure. That is, the indication to initiate the procedure may include UE 205 sending, transmitting, or otherwise providing for output the message in the resource(s) (e.g., specific time, frequency, or spatial resource(s)). The resources may be generally associated with any/all passive devices (e.g., a signal that the passive devices support receiving) or may be associated with a group or individual ones of the proximate passive devices (e.g. resource(s) associated with specific passive device identifier(s)). A passive device receiving the message on the associated resource may initiate the passive device identification procedure with UE 205.

In some examples, this may include UE 205 or network entity 210 selecting or otherwise configuring the message to indicate whether the passive device identification procedure is being initiated only for passive devices with new data to transmit or for all passive devices. For example, UE 205 may request a response signal from passive devices with new data to communicate, from passive devices with no new data to communicate, or both.

In some examples, this may include UE 205 or network entity 210 selecting or otherwise configuring the message initiating the procedure to include identifier(s) of specific passive devices. For example, UE 205 may have previously communicated with the proximate passive devices and therefore maintain certain information regarding previously communicated with passive devices. UE 205 may configure the initiating message to include or otherwise convey an indication of identifier(s) of known passive devices to specifically request their participation in the procedure (e.g., to confirm continued presence based a threshold delay communicating with certain passive devices).

Accordingly, to support reading data from passive devices, configuring the message initiating the procedure to include identifier(s) of passive devices, this may enable passive devices to determine whether to participate in the passive device identification procedure (e.g., whether to transmit a response signal to UE 205). For example, a passive device with no new data to communicate to UE 205 that receives a message indicating its identifier as well as an old/new data indication might determine to respond with a response signal (e.g., to update its presence/information with UE 205) or may determine not to respond with a response signal (e.g., to conserve power when there is no new data to communicate).

In some aspects, the passive device identification procedure may include UE 205 transmitting or otherwise providing for output one or more reference signals. Generally, the reference signals may include a wireless signal that is utilized by the passive device(s) to backscattering communication techniques (e.g., for reflecting from the passive device according to backscattering techniques to communicate data. For example, the reference signal(s) may be transmitted or otherwise provided for output at a frequency and amplitude that may support backscattering by the passive devices. In one non-limiting example, this may include UE 205 transmitting or otherwise providing for output a set of M time domain multiplexed reference signals, where each responding passive device may reflect at least one of the M reference signal(s), and M is a positive integer. In some examples, the reference signals are transmitted by UE 205 or may be transmitted by network entity 210 (e.g., network entity 210 is the transmitting side of the reader device and UE 205 is the reader side of the reader device receiving response signals).

Accordingly, the passive device identification procedure may include UE 205 receiving or otherwise obtaining one or more response signals from one, some, or all (e.g., at least a portion) of the proximate passive devices. For example, UE 205 may receive or otherwise obtain response signals from UE 215, UE 220, UE 225, or some combination thereof, in response to the reference signal transmission(s). Broadly, this may include UE 205 monitoring, measuring, or otherwise determining a multi-path channel, where the number of paths may provide a coarse indication of a number of passive devices. That is, UE 205 may identify or otherwise determine the numerical quantity (e.g., how many) of passive devices that are located proximate to UE 205 based on the number of response signal(s) (e.g., how many) were received in response to the reference signal(s).

Additionally, or alternatively, UE 205 may identify or otherwise determine which passive devices are proximate based on a time delay associated with the response signal(s). For example, each passive device may be associated with a specific time delay to be applied when reflecting the reference signal to UE 205. Accordingly, UE 205 may identify or otherwise determine a time delay for each received response signal and then identify or otherwise determine identifying information for each passive device providing a response signal based on the time delay of the response signal (e.g., in relation to the reference signal, the message initiating the procedure, or both). Accordingly, in some examples each passive device may add a time delay (e.g., when configured to support such functionality) to improve response signal separation at the reader device (e.g., UE 205). This may include passive devices buffering instances of a CW signal (e.g., the reference signal), and the reflecting a buffered instance at the associated time delay. In some aspects, the time delay associated with specific passive devices may be (pre) configured, randomly selected by each passive device, or may be a function (e.g., hash) of the identifier of the passive device. Accordingly, UE 205 may detect or otherwise determine the presence of a given passive device (and thereby identify the passive device) based on the tap (e.g., in the time domain) of the response signal.

Additionally, or alternatively, UE 205 may identify or otherwise determine which passive devices are proximate based on a sequence associated with the response signal(s). For example, each passive device may be associated with a specific sequence (e.g., a sequence of bits) to be applied (e.g., conveyed) when reflecting the reference signal to UE 205. The passive devices may use different s (n) sequences during the passive device identification procedure. This may enable UE 205 to count/determine which passive devices are proximate. For example, UE 205 may identify or otherwise determine a sequence indicated in each response signal and then identify the passive devices based on the sequence. In some examples, the sequences communicated in the response signals may be orthogonal or otherwise have a threshold amount of cross-correlation properties to support decoupling the response signals at the reader (e.g., UE 205), such as when multiple overlapping response signals are received.

Additionally, or alternatively, UE 205 may identify or otherwise determine which passive devices are proximate based on a backscattering pulse repetition interval time (TPRI) associated with the response signals. For example, each passive device may apply a different TPRI when transmitting (e.g., backscattering) the response signal to UE 205. UE 205 may identify or otherwise determine the TPRI indicated (e.g., applied to) each response signal and identify the passive device based on the TPRI.

Accordingly, UE 205 may identify or otherwise determine how many (e.g., a numerical quantity), which ones (e.g., identifiers of), or both, passive devices are proximate based on the response signal(s) received responsive to the reference signal(s). Accordingly, UE 205 may communicate with the passive devices according to scheduling based, at least to some degree, on the response signals. That is, detecting the presence of, identifying, or both, the passive devices that are proximate to UE 205 may provide information used to improve scheduling for the communications. For example, resource allocation, interference management/mitigation, configuration, and other such wireless communication features/functions may be improved when the proximate passive devices are known.

In some examples, this may include UE 205 autonomously selecting or otherwise identifying resources to allocate for the communications with the passive devices. For example, UE 205 may be configured with or otherwise be configured to select resources from a set of available resources to use when scheduling communications with the passive devices. One non-limiting example of this is a sidelink communication scenario where UE 205 may be a scheduling UE within the sidelink network. For example, network entity 210 may (pre) configure UE 205 with a pool of available sidelink resources that UE 205 may select from when scheduling communications with UE 215, UE 220, UE 225, or some combination thereof.

In some examples, this may include UE 205 coordinating with network entity 210 when scheduling resources for communications with the passive devices. For example, UE 205 may transmit or otherwise provide for output a signal (e.g., RRC signaling, an uplink control information (UCI), a scheduling request, a UE assistance information request, a physical uplink shared channel (PUSCH) signal, a physical sidelink shared channel (PSSCH), or a sidelink control information (SCI)) to network entity 210 indicating passive device information that is based, at least to some degree, on the passive device identification procedure. For example, UE 205 may include the numerical quantity of passive devices in the signal.

In some examples, this may include UE 205 reporting an estimated number of passive devices to network entity 210 via a dedicated uplink channel. When M reference signals were transmitted (e.g., by UE 205 or by network entity 210) and UE 205 detects a different number of passive device response signals on each reference signal, UE 205 may report the number of detected passive devices responding on each reference signal, a maximum, average, or actual number of passive devices responding on each reference signal, a minimum, a maximum, a minimum average, or a maximum average of passive devices responding on each or all of the reference signals.

In response, network entity 210 may use the number of passive devices, the identifiers of the passive devise, or both, when determining which passive devices to read from and the resources to be used for reading from passive devices. For example, UE 205 or network entity 210 may trigger a certain tag (e.g., to initiate a new data upload) by sending a signal preamble based on the identifier of the passive device. network entity 210 may transmit or otherwise provide for output control signaling scheduling the resource(s) or otherwise configuring various parameters to use for communication between UE 205 and the passive devices. UE 205 may receive the control signaling from network entity 210 and schedule the communications with the passive device(s) using the resources.

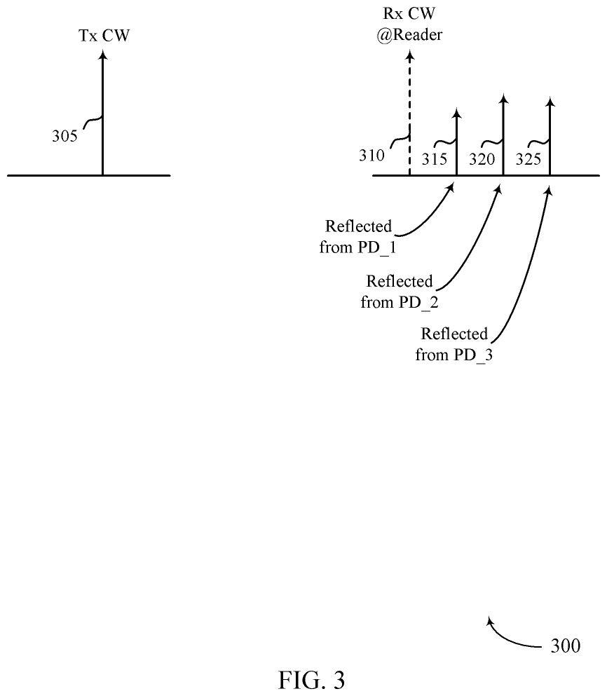

FIG. 3 illustrates an example of a signal configuration 300 that supports detecting passive devices proximate to a reader device in accordance with one or more aspects of the present disclosure. Signal configuration 300 may implement aspects of wireless communication system 100 or 200. Aspects of signal configuration 300 may be implemented at a passive device or a reader device, which may be examples of the corresponding devices described herein. For example, a reader device may be an example of a UE, as discussed herein.

As discussed above, aspects of the techniques described herein generally provide for a passive device identification procedure between a UE and passive device(s) located proximate to the UE (e.g., within a threshold distance). Broadly, the passive device identification procedure may include, at least to some degree, using backscattering communication techniques between the UE and the proximate passive devices. For example, the UE may broadcast, transmit, or otherwise provide for output a message initiating the passive device identification procedure for the proximate passive devices. In some examples, the message may be broadcast on a resource associated with passive devices generally, associated with a group of passive devices, or associated with individual passive devices. In some examples, the message may include one or more identifiers associated with passive devices that are being requested to participate in the passive device identification procedure. In some examples, the message may include one or more bits or fields indicating or otherwise conveying an indication of whether the passive device identification procedure is being initiated for passive devices with new data to communicate or for any/all passive devices proximate to the UE (e.g., also for passive devices with no new data to communicate).

The UE then transmit or otherwise provide for output one or more reference signals according to the passive device identification procedure. For example and based at least in part on the message initiating the procedure, the UE may (or a network entity associated with the UE) transmit or otherwise provide for output a CW 305 to the proximate passive devices. In response, the UE may receive response signal(s) from passive device(s) proximate to the UE.

For example, the reader device (e.g., the UE transmitting CW 305 or a separate UE/reader device receiving the response signals) may receive the original CW as a received CW 310. The received CW 310 may generally correspond to at least a portion of the original CW (e.g., CW 305) returned to the UE due to signal propagation (e.g. the original CW is reflected by surrounding structures or environment). The UE may also receive response signals from passive devices participating in the passive device identification procedure. Signal configuration 300 illustrates a non-limiting example where M time domain multiplexed reference signals are transmitted and the UE receives a multi-path channel, where M is a positive integer and the number of paths provide a coarse indication of the number of passive devices proximate to the UE. For example, the UE may receive a first response signal at a reflected wave 315 (e.g., the backscattered reflection of the reference signal) from a first passive device (PD_1), a second response signal at a reflected wave 320 from a second passive device (PD_2), and a third response signal at a reflected wave 325 from a third passive device (PD_3). Receiving three response signals on three different taps provides an indication that there are three passive devices proximate to the UE that are participating in the procedure.

Accordingly, the UE may communicate with the passive devices according to scheduling that is based on the response signals. For example, the UE, the network entity, or both, may schedule communications with the passive devices using an appropriate amount of resources to support communications with/avoid interference from the UE and three passive devices.

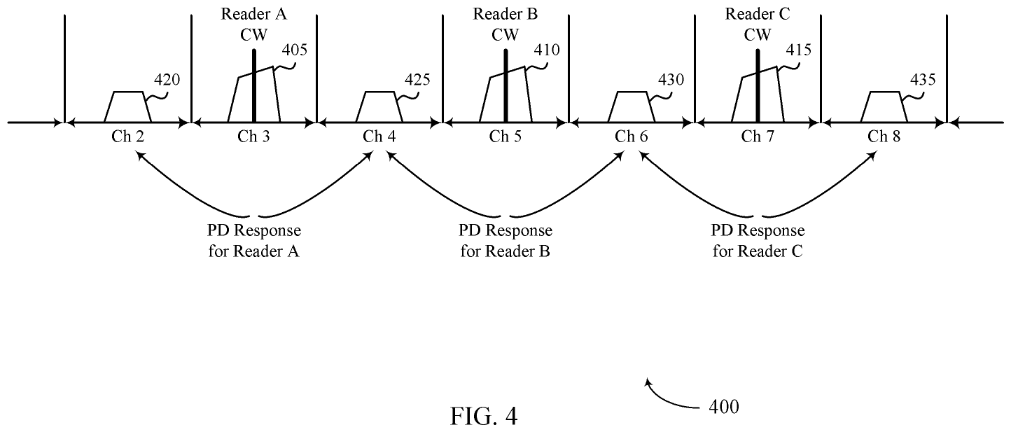

FIG. 4 illustrates an example of a signal configuration 400 that supports detecting passive devices proximate to a reader device in accordance with one or more aspects of the present disclosure. Signal configuration 400 may implement aspects of wireless communication system 100 or 200. Aspects of signal configuration 400 may be implemented at a passive device or a reader device, which may be examples of the corresponding devices described herein. For example, a reader device may be an example of a UE, as discussed herein.

As discussed above, aspects of the techniques described herein generally provide for a passive device identification procedure between a UE and passive device(s) located proximate to the UE (e.g., within a threshold distance). Broadly, the passive device identification procedure may include, at least to some degree, using backscattering communication techniques between the UE and the proximate passive devices. For example, the UE may broadcast, transmit, or otherwise provide for output a message initiating the passive device identification procedure for the proximate passive devices. In some examples, the message may be broadcast on a resource associated with passive devices generally, associated with a group of passive devices, or associated with individual passive devices. In some examples, the message may include one or more identifiers associated with passive devices that are being requested to participate in the passive device identification procedure. In some examples, the message may include one or more bits or fields indicating or otherwise conveying an indication of whether the passive device identification procedure is being initiated for passive devices with new data to communicate or for any/all passive devices proximate to the UE (e.g., also for passive devices with no new data to communicate).

The UE then transmit or otherwise provide for output one or more reference signals according to the passive device identification procedure. For example and based at least in part on the message initiating the procedure, the UE may (or a network entity associated with the UE) transmit or otherwise provide for output a CW to the proximate passive devices. In response, the UE may receive response signal(s) from passive device(s) proximate to the UE.

As discussed above, aspects of the techniques described herein support different TPRI for different passive devices participating in the passive device identification procedure. During the procedure, passive devices may be configured to use (e.g., apply, indicate, or otherwise convey) TPRI values when providing response signals. Using different TPRI values may enable decoupling the response signals in the frequency domain.

That is, aspects of the techniques discussed herein provide for or otherwise introduce different frequency shifts to the CW to decouple the passive devices in the frequency domain. The CW frequency shift (e.g., the shift of the CW in the frequency domain) configured for or otherwise applied by passives devices responding to the one or more reference signals may be configured on a per-passive device basis or on a per-passive device group basis. Each passive device applying its (pre) configured frequency shift when responding to the reference signal(s) may indicate the identifier of the passive device (or other identifying information) using the (pre) configured frequency shift.

In some examples, aspects of the techniques discussed herein provide for or otherwise introduce different modulation rates used in the CW to decouple or otherwise distinguish the passive devices (e.g., TPRI, backscatter). The modulation rate (e.g., the modulation rate applied to the CW response signal) configured for or otherwise applied by passives devices responding to the one or more reference signals may be configured on a per-passive device basis or on a per-passive device group basis. Each passive device applying its (pre) configured modulation rate when responding to the reference signal(s) may indicate the identifier of the passive device (or other identifying information) using the (pre) configured modulation rate.

In some examples, aspects of the techniques discussed herein provide for or otherwise introduce power domain randomization used in the CW to decouple or otherwise distinguish the passive devices. For example, each passive device may initiate, configure, or otherwise set up a timer based on the received power (e.g., when responding to the reference signal(s) using backscattering). In some examples, the timer may be set to a value that is proportional to the received power level (e.g., the power level that the passive device received the reference signal(s)). For example, more distant passive devices may be able to provide response signals first. In some examples, the timer may be set to a value that is inversely proportional to the received power level (e.g., the power level that the passive device received the reference signal(s)). For example, more distant passive devices may be able to provide response signals last (e.g., to provide time for the passive devices to accumulate more energy from the reference signal(s)). The power domain randomization (e.g., when/which order to respond to the reference signal(s)) may be configured for or otherwise applied by passives devices responding to the one or more reference signals may be configured on a per-passive device basis or on a per-passive device group basis. Each passive device applying its (pre) configured power domain randomization when responding to the reference signal(s) may indicate the identifier of the passive device (or other identifying information) using the (pre) configured power domain randomization.

For example, the UE, alone or in cooperation with a network entity, may configure the passive devices with sets of TPRI values, with each passive device randomly selecting a TPRI value or selecting the TPRI value based on a criterion (e.g., such as identifying information of the UE or the passive device). Accordingly, the UE, alone or in cooperation with the network entity, may (pre) configure proximate passive devices with different frequency shifts/offsets, different TPRI values, and/or different modulation rates to indicate identifier(s) (or other identifying information) of the passive devices providing response signals to the one or more reference signals. Again, the passive devices discussed herein may include passive and/or semi-passive devices (e.g., passive and semi-active RFID tags).

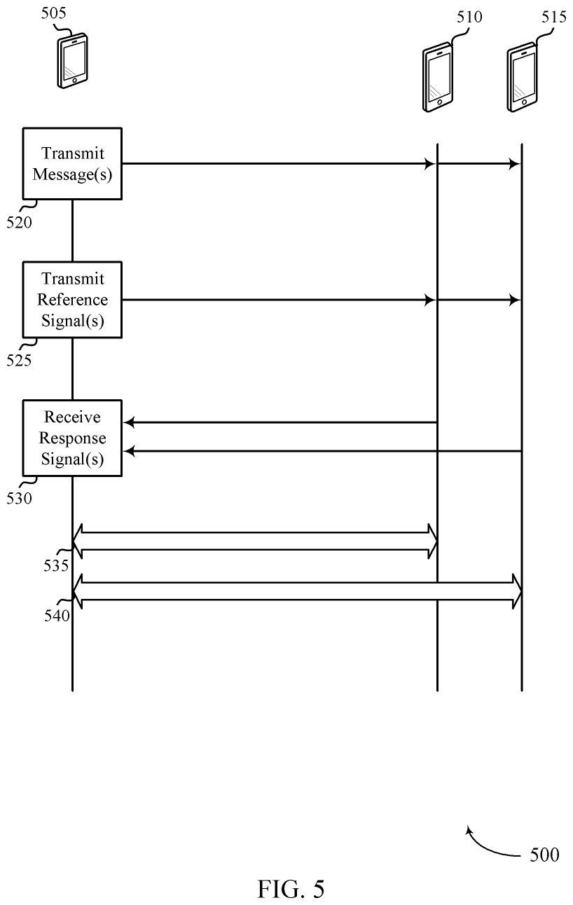

The non-limiting example illustrated in FIG. 5 includes a first reader (e.g., Reader A) transmitting a CW at a center frequency in channel 3 having a first waveform 405 (e.g., a first reference signal). The first reader device in this example may be configured to receive response signals from two passive devices located on channels 2 and 4. For example, the first reader device may receive a first response signal 420 from a first passive device (PD) and a second response signal 425 from a second passive device. A second reader device (e.g., Reader B) may be configured to transmit a CW at a center frequency in channel 5 having a second waveform 410 (e.g., a second reference signal). The second reader device in this example may be configured to receive the second response signal 425 (from first or second reader device) and a third response signal 430 from a third passive device. A third reader device (e.g., Reader C) may be configured to transmit a CW at a center frequency in channel 7 having a third waveform 415 (e.g., a third reference signal). The third reader device in this example may be configured to receive the third response signal 430 (from the second or third reader device) and a fourth response signal 435 from a fourth passive device.

Accordingly, the UE (e.g., implementing or otherwise associated with Readers A-C) may identify or otherwise determine that there are four passive devices based on the response signals and schedule communications with the passive devices accordingly. For example, the UE, alone or in cooperation with a network entity, may allocate or otherwise configure a sufficient amount of resources to use for the communications with the passive devices based on the response signals.

FIG. 5 illustrates an example of a method 500 that supports detecting passive devices proximate to a reader device in accordance with one or more aspects of the present disclosure. Method 500 may implement aspects of wireless communication systems 100 or 200 or aspects of signal configurations 300 or 400. Aspects of method 500 may be implemented at UE 505, UE 510, or UE 515, which may be examples of the corresponding devices described herein. For example, UE 505 may be an example of a reader device, while UE 510 and UE 515 may be examples of passive devices, as discussed herein.

At 520, UE 505 may transmit or otherwise provide for output a message. In some examples, UE 505 may broadcast the message in a broadcast transmission or in a groupcast transmission. In some examples, the message may initiate a passive device identification procedure. In some examples, the procedure may be initiated for passive devices proximate to UE 505 (such as UE 510, UE 515, or both). In some examples, this may include passive devices within a threshold distance or range of UE 505. In some examples, UE 505 may broadcast a single message to UE 510 and UE 515 initiating the procedure. In some examples, UE 505 may broadcast multiple messages to UE 510 and UE 515 initiating the procedure.

In some examples, UE 505 may broadcast the message on a given resource. In some examples, the given resource may be a specific resource that is associated with the procedure. In some examples, the given resource may be a specific resource that is associated with passive devices. In some examples, the given resource may be a specific resource that is associated with a group of passive devices. In some examples, the given resource may be a specific resource that is associated with any passive device participating in the procure. In some examples, the message may carry or otherwise convey an indication of identifiers. In some examples, the identifiers may be for specific passive devices being requested to participate in the procedure. In some examples, the identifiers may be for specific passive devices previously determined to be proximate to the UE. In some examples, the message may carry or otherwise convey an indication of whether the procedure is for passive devices with new data to communicate or for all passive devices (e.g., even for passive devices with no new data to communicate).

At 525, UE 505 may transmit or otherwise provide reference signal(s). In some examples, the reference signal(s) may be transmitted as part of the passive device identification procedure. In some examples, the reference signal(s) may include M time domain multiplexed CW transmissions from UE 505, where M is a positive integer. In some examples, the reference signal(s) may be used by the passive device when backscattering (e.g., reflecting) the reference signals back to UE 505.

At 530, UE 510, UE 515, or both, may transmit or otherwise provide for output (and UE 505 may receive or otherwise obtain) response signal(s). In some examples, the response signal(s) may be communicated using backscattering-based communications. In some examples, this may include the passive devices reflecting the reference signal back to UE 505. In some examples, the response signal(s) may be reflected according to the backscattering techniques to carry or otherwise convey bits (e.g. a sequence). In some examples, the response signal(s) may have a time delay applied. In some examples, each passive device providing the response signal(s) may apply a unique time delay when transmitting the response signal, with each passive device being associated with a different response signal.

At 535, UE 505 may communicate with UE 510 according to scheduling based on the response signal received from UE 510. In some examples, this may include UE 505 scheduling or otherwise allocating resources to use for the communications based on the response signal received from UE 510.

At 540, UE 505 may communicate with UE 515 according to scheduling based on the response signal received from UE 515. In some examples, this may include UE 505 scheduling or otherwise allocating resources to use for the communications based on the response signal received from UE 515.

Accordingly, UE 505 may make improved scheduling decisions when scheduling communications with its proximate passive devices (e.g., UE 510 and UE 515) based on the passive device identification procedure.

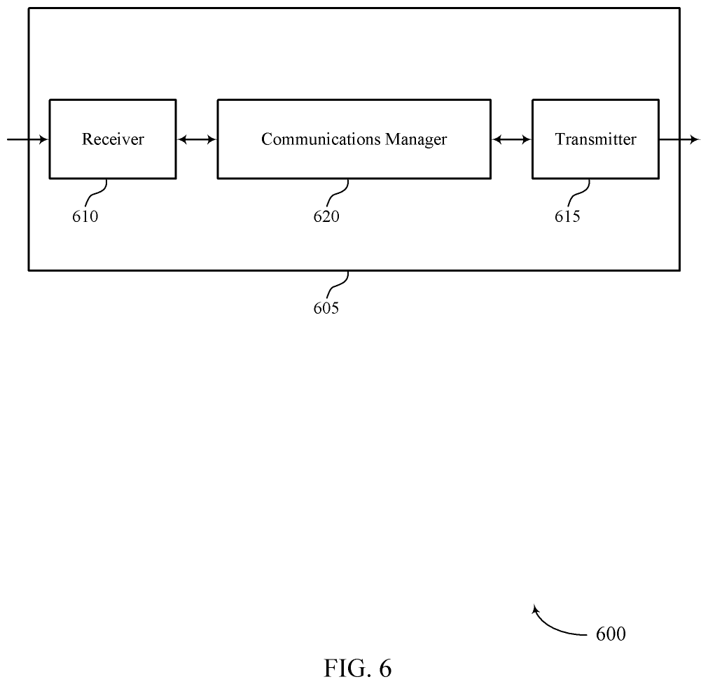

FIG. 6 shows a block diagram 600 of a device 605 that supports detecting passive devices proximate to a reader device in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to detecting passive devices proximate to a reader device). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to detecting passive devices proximate to a reader device). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of detecting passive devices proximate to a reader device as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry), software (e.g., executable by a processor), or any combination thereof. The hardware may include a processor, a digital signal processor (DSP), a central processing unit (CPU), a graphics processor unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software) executed by a processor. If implemented in code executed by a processor, the functions of the communications manager 620, the receiver 610, the transmitter 615, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. For example, the communications manager 620 may be configured as or otherwise support a means for broadcasting a message initiating a passive device identification procedure for one or more passive devices located proximate to the UE. The communications manager 620 may be configured as or otherwise support a means for transmitting one or more reference signals based on the message and according to the passive device identification procedure. The communications manager 620 may be configured as or otherwise support a means for receiving a set of one or more response signals from at least a portion of the one or more passive devices based on at least one of the one or more reference signals. The communications manager 620 may be configured as or otherwise support a means for communicating with at least the portion of the one or more passive devices according to scheduling that is based on the set of one or more response signals.

Additionally, or alternatively, the communications manager 620 may support wireless communication at a passive device in accordance with examples as disclosed herein. For example, the communications manager 620 may be configured as or otherwise support a means for receiving a message initiating a passive device identification procedure for one or more passive devices located proximate to a UE. The communications manager 620 may be configured as or otherwise support a means for receiving at least one reference signal of a set of one or more reference signals based on the message and according to the passive device identification procedure. The communications manager 620 may be configured as or otherwise support a means for transmitting a response signal to the UE based on the at least one reference signal. The communications manager 620 may be configured as or otherwise support a means for communicating with the UE according to scheduling that is based on the response signal.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for a passive device identification procedure where a UE initiates the procedure with proximate passive devices and then identifies or otherwise quantifies the proximate devices based on response signals reflected (e.g., backscattered) from the passive devices in response to reference signal transmission(s).

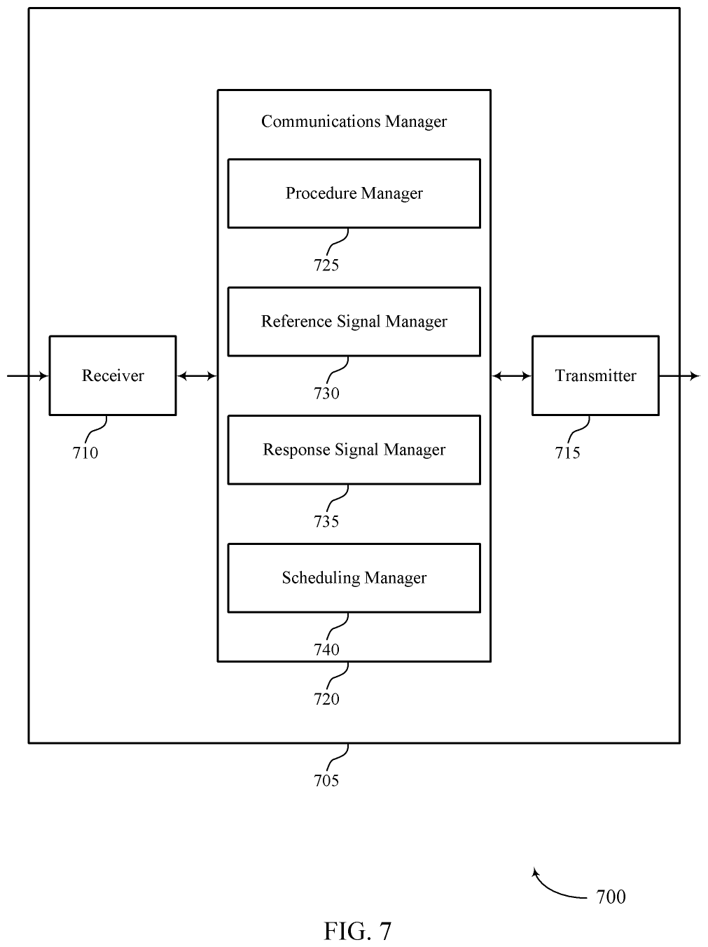

FIG. 7 shows a block diagram 700 of a device 705 that supports detecting passive devices proximate to a reader device in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to detecting passive devices proximate to a reader device). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to detecting passive devices proximate to a reader device). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of detecting passive devices proximate to a reader device as described herein. For example, the communications manager 720 may include a procedure manager 725, a reference signal manager 730, a response signal manager 735, a scheduling manager 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The procedure manager 725 may be configured as or otherwise support a means for broadcasting a message initiating a passive device identification procedure for one or more passive devices located proximate to the UE. The reference signal manager 730 may be configured as or otherwise support a means for transmitting one or more reference signals based on the message and according to the passive device identification procedure. The response signal manager 735 may be configured as or otherwise support a means for receiving a set of one or more response signals from at least a portion of the one or more passive devices based on at least one of the one or more reference signals. The scheduling manager 740 may be configured as or otherwise support a means for communicating with at least the portion of the one or more passive devices according to scheduling that is based on the set of one or more response signals.

Additionally, or alternatively, the communications manager 720 may support wireless communication at a passive device in accordance with examples as disclosed herein. The procedure manager 725 may be configured as or otherwise support a means for receiving a message initiating a passive device identification procedure for one or more passive devices located proximate to a UE. The reference signal manager 730 may be configured as or otherwise support a means for receiving at least one reference signal of a set of one or more reference signals based on the message and according to the passive device identification procedure. The response signal manager 735 may be configured as or otherwise support a means for transmitting a response signal to the UE based on the at least one reference signal. The scheduling manager 740 may be configured as or otherwise support a means for communicating with the UE according to scheduling that is based on the response signal.

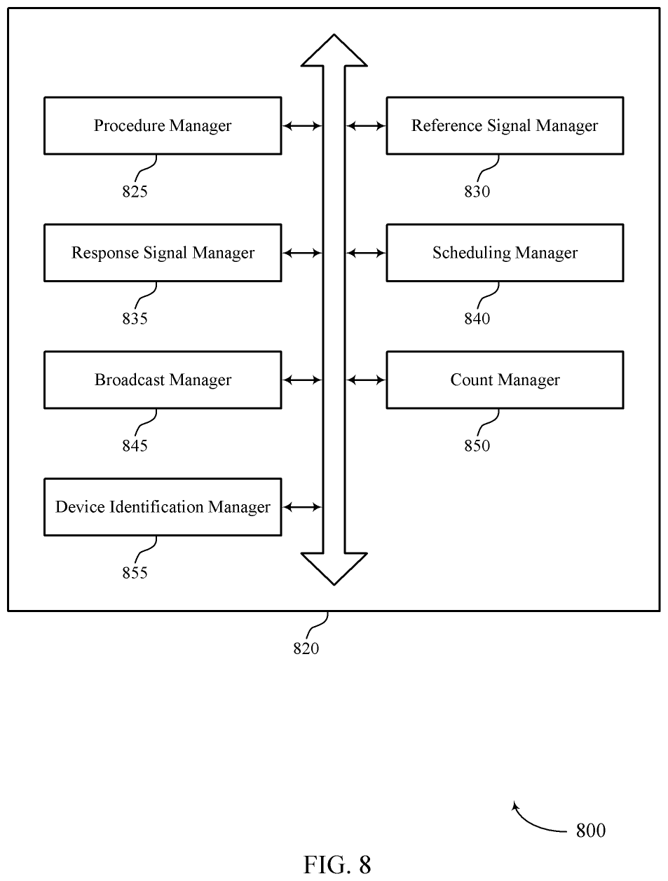

FIG. 8 shows a block diagram 800 of a communications manager 820 that supports detecting passive devices proximate to a reader device in accordance with one or more aspects of the present disclosure. The communications manager 820 may be an example of aspects of a communications manager 620, a communications manager 720, or both, as described herein. The communications manager 820, or various components thereof, may be an example of means for performing various aspects of detecting passive devices proximate to a reader device as described herein. For example, the communications manager 820 may include a procedure manager 825, a reference signal manager 830, a response signal manager 835, a scheduling manager 840, a broadcast manager 845, a count manager 850, a device identification manager 855, or any combination thereof. Each of these components may communicate, directly or indirectly, with one another (e.g., via one or more buses).

The communications manager 820 may support wireless communication at a UE in accordance with examples as disclosed herein. The procedure manager 825 may be configured as or otherwise support a means for broadcasting a message initiating a passive device identification procedure for one or more passive devices located proximate to the UE. The reference signal manager 830 may be configured as or otherwise support a means for transmitting one or more reference signals based on the message and according to the passive device identification procedure. The response signal manager 835 may be configured as or otherwise support a means for receiving a set of one or more response signals from at least a portion of the one or more passive devices based on at least one of the one or more reference signals. The scheduling manager 840 may be configured as or otherwise support a means for communicating with at least the portion of the one or more passive devices according to scheduling that is based on the set of one or more response signals.

In some examples, to support broadcasting the message, the broadcast manager 845 may be configured as or otherwise support a means for selecting one or more resources associated with the one or more passive devices, where the message is broadcast on the one or more resources. In some examples, to support broadcasting the message, the broadcast manager 845 may be configured as or otherwise support a means for requesting, via the message, a response signal from one or more of: passive devices of the one or more passive devices with new data to communicate, passive devices of the one or more passive devices with no new data to communicate, or both.

In some examples, to support broadcasting the message, the broadcast manager 845 may be configured as or otherwise support a means for including in the message an identifier associated with each of the one or more passive devices, where the set of one or more response signals are received based on the identifier indicated in the message.

In some examples, the count manager 850 may be configured as or otherwise support a means for identifying a numerical quantity of passive devices located proximate to the UE based on a number of response signals in the set of one or more response signals. In some examples, the count manager 850 may be configured as or otherwise support a means for transmitting a signal to a network entity indicating the numerical quantity of passive devices located proximate to the UE.

In some examples, the count manager 850 may be configured as or otherwise support a means for receiving a control signal scheduling a resource to use for the communicating, where the resource is based on the indication of the numerical quantity. In some examples, the count manager 850 may be configured as or otherwise support a means for selecting, based on the numerical quantity, resources from a set of available resources to use for the communicating. In some examples, the count manager 850 may be configured as or otherwise support a means for scheduling the communications with at least the portion of the one or more passive devices using the resources.

In some examples, the device identification manager 855 may be configured as or otherwise support a means for identifying, for each response signal in the set of one or more response signals, a time delay for the response signal. In some examples, the device identification manager 855 may be configured as or otherwise support a means for identifying each passive device in at least the portion of the one or more passive devices based on the time delay of the response signal.

In some examples, the device identification manager 855 may be configured as or otherwise support a means for identifying, for each response signal in the set of one or more response signals, a sequence indicated in the response signal. In some examples, the device identification manager 855 may be configured as or otherwise support a means for identifying each passive device in at least the portion of the one or more passive devices based on the sequence indicated in the response signal.

In some examples, the device identification manager 855 may be configured as or otherwise support a means for identifying, for each response signal in the set of one or more response signals, a TPRI indicated in the response signal. In some examples, the device identification manager 855 may be configured as or otherwise support a means for identifying each passive device in at least the portion of the one or more passive devices based on the TPRI indicated in the response signal.

In some examples, the device identification manager 855 may be configured as or otherwise support a means for identifying each passive device in at least the portion of the one or more passive devices based at least in part on a frequency shift of each response signal in the set of one or more response signals.

In some examples, the device identification manager 855 may be configured as or otherwise support a means for identifying each passive device in at least the portion of the one or more passive devices based at least in part on a modulation rate of each response signal in the set of one or more response signals.

In some examples, the device identification manager 855 may be configured as or otherwise support a means for identifying identify each passive device in at least the portion of the one or more passive devices based at least in part on a power domain randomization of each response signal in the set of one or more response signals.

In some examples, the one or more passive devices include at least one of a proximate UE, an IoT device, a passive RFID device, a semi-active RFID device, a device supporting backscattering-based communications, or a combination thereof.

Additionally, or alternatively, the communications manager 820 may support wireless communication at a passive device in accordance with examples as disclosed herein. In some examples, the procedure manager 825 may be configured as or otherwise support a means for receiving a message initiating a passive device identification procedure for one or more passive devices located proximate to a UE. In some examples, the reference signal manager 830 may be configured as or otherwise support a means for receiving at least one reference signal of a set of one or more reference signals based on the message and according to the passive device identification procedure. In some examples, the response signal manager 835 may be configured as or otherwise support a means for transmitting a response signal to the UE based on the at least one reference signal. In some examples, the scheduling manager 840 may be configured as or otherwise support a means for communicating with the UE according to scheduling that is based on the response signal.

In some examples, the broadcast manager 845 may be configured as or otherwise support a means for determining that the message was received on a resource associated with the passive device. In some examples, the broadcast manager 845 may be configured as or otherwise support a means for determining that the message requests a response signal from one or more of: one or more passive devices with new data to communication, one or more passive devices with no new data to communicate, or both.

In some examples, the device identification manager 855 may be configured as or otherwise support a means for delaying transmitting the response signal according to a time delay associated with the passive device. In some examples, the device identification manager 855 may be configured as or otherwise support a means for including a sequence associated with the passive device in the response signal. In some examples, the device identification manager 855 may be configured as or otherwise support a means for including a TPRI associated with the passive device in the response signal.

In some examples, the device identification manager 855 may be configured as or otherwise support a means for applying a frequency shift associated with the passive device for the response signal. In some examples, the device identification manager 855 may be configured as or otherwise support a means for applying a modulation rate associated with the passive device for the response signal. In some examples, the device identification manager 855 may be configured as or otherwise support a means for applying a power domain randomization associated with the passive device for the response signal.

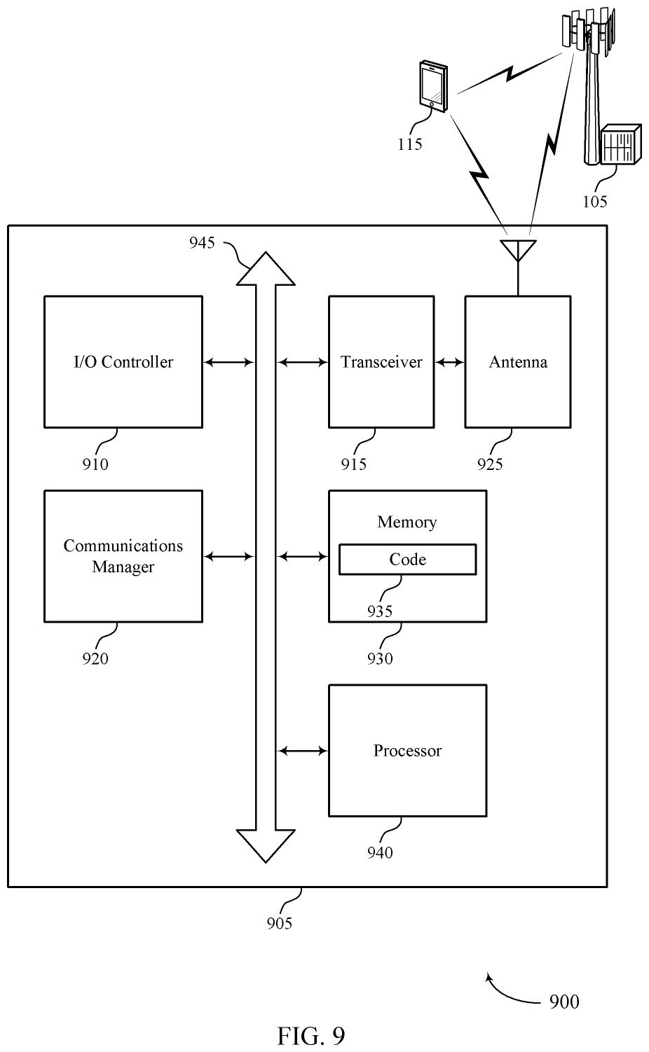

FIG. 9 shows a diagram of a system 900 including a device 905 that supports detecting passive devices proximate to a reader device in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2R, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting detecting passive devices proximate to a reader device). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for broadcasting a message initiating a passive device identification procedure for one or more passive devices located proximate to the UE. The communications manager 920 may be configured as or otherwise support a means for transmitting one or more reference signals based on the message and according to the passive device identification procedure. The communications manager 920 may be configured as or otherwise support a means for receiving a set of one or more response signals from at least a portion of the one or more passive devices based on at least one of the one or more reference signals. The communications manager 920 may be configured as or otherwise support a means for communicating with at least the portion of the one or more passive devices according to scheduling that is based on the set of one or more response signals.

Additionally, or alternatively, the communications manager 920 may support wireless communication at a passive device in accordance with examples as disclosed herein. For example, the communications manager 920 may be configured as or otherwise support a means for receiving a message initiating a passive device identification procedure for one or more passive devices located proximate to a UE. The communications manager 920 may be configured as or otherwise support a means for receiving at least one reference signal of a set of one or more reference signals based on the message and according to the passive device identification procedure. The communications manager 920 may be configured as or otherwise support a means for transmitting a response signal to the UE based on the at least one reference signal. The communications manager 920 may be configured as or otherwise support a means for communicating with the UE according to scheduling that is based on the response signal.

By including or configuring the communications manager 920 in accordance with examples as described herein, the device 905 may support techniques for a passive device identification procedure where a UE initiates the procedure with proximate passive devices and then identifies or otherwise quantifies the proximate devices based on response signals reflected (e.g., backscattered) from the passive devices in response to reference signal transmission(s).

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of detecting passive devices proximate to a reader device as described herein, or the processor 940 and the memory 930 may be otherwise configured to perform or support such operations.

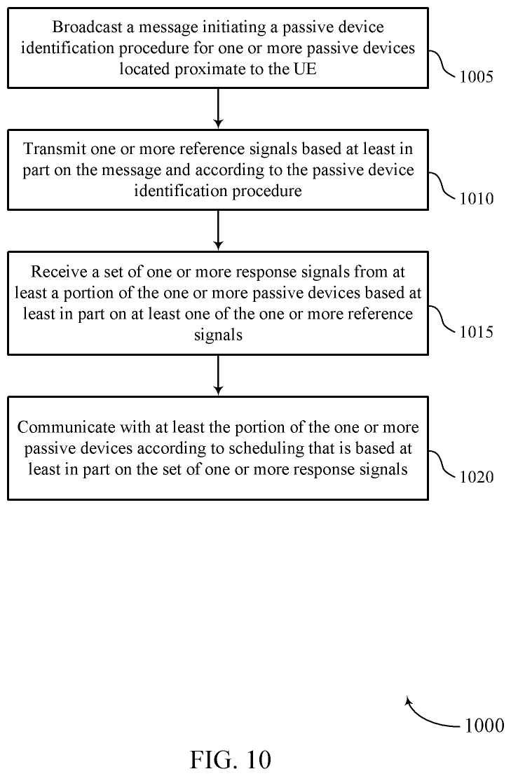

FIG. 10 shows a flowchart illustrating a method 1000 that supports detecting passive devices proximate to a reader device in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include broadcasting a message initiating a passive device identification procedure for one or more passive devices located proximate to the UE. The operations of 1005 may be performed in accordance with examples as disclosed herein. In some examples, aspects of the operations of 1005 may be performed by a procedure manager 825 as described with reference to FIG. 8.

At 1010, the method may include transmitting one or more reference signals based on the message and according to the passive device identification procedure. The operations of 1010 may be performed in accordance with examples as disclosed herein. In some examples, aspects of the operations of 1010 may be performed by a reference signal manager 830 as described with reference to FIG. 8.

At 1015, the method may include receiving a set of one or more response signals from at least a portion of the one or more passive devices based on at least one of the one or more reference signals. The operations of 1015 may be performed in accordance with examples as disclosed herein. In some examples, aspects of the operations of 1015 may be performed by a response signal manager 835 as described with reference to FIG. 8.

At 1020, the method may include communicating with at least the portion of the one or more passive devices according to scheduling that is based on the set of one or more response signals. The operations of 1020 may be performed in accordance with examples as disclosed herein. In some examples, aspects of the operations of 1020 may be performed by a scheduling manager 840 as described with reference to FIG. 8.

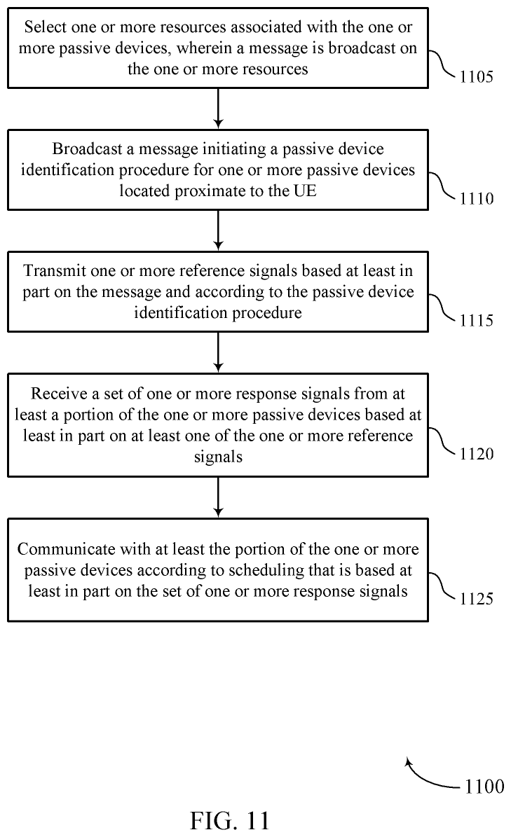

FIG. 11 shows a flowchart illustrating a method 1100 that supports detecting passive devices proximate to a reader device in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include selecting one or more resources associated with the one or more passive devices, where a message is broadcast on the one or more resources. The operations of 1105 may be performed in accordance with examples as disclosed herein. In some examples, aspects of the operations of 1105 may be performed by a broadcast manager 845 as described with reference to FIG. 8.

At 1110, the method may include broadcasting a message initiating a passive device identification procedure for one or more passive devices located proximate to the UE. The operations of 1110 may be performed in accordance with examples as disclosed herein. In some examples, aspects of the operations of 1110 may be performed by a procedure manager 825 as described with reference to FIG. 8.

At 1115, the method may include transmitting one or more reference signals based on the message and according to the passive device identification procedure. The operations of 1115 may be performed in accordance with examples as disclosed herein. In some examples, aspects of the operations of 1115 may be performed by a reference signal manager 830 as described with reference to FIG. 8.

At 1120, the method may include receiving a set of one or more response signals from at least a portion of the one or more passive devices based on at least one of the one or more reference signals. The operations of 1120 may be performed in accordance with examples as disclosed herein. In some examples, aspects of the operations of 1120 may be performed by a response signal manager 835 as described with reference to FIG. 8.

At 1125, the method may include communicating with at least the portion of the one or more passive devices according to scheduling that is based on the set of one or more response signals. The operations of 1125 may be performed in accordance with examples as disclosed herein. In some examples, aspects of the operations of 1125 may be performed by a scheduling manager 840 as described with reference to FIG. 8.

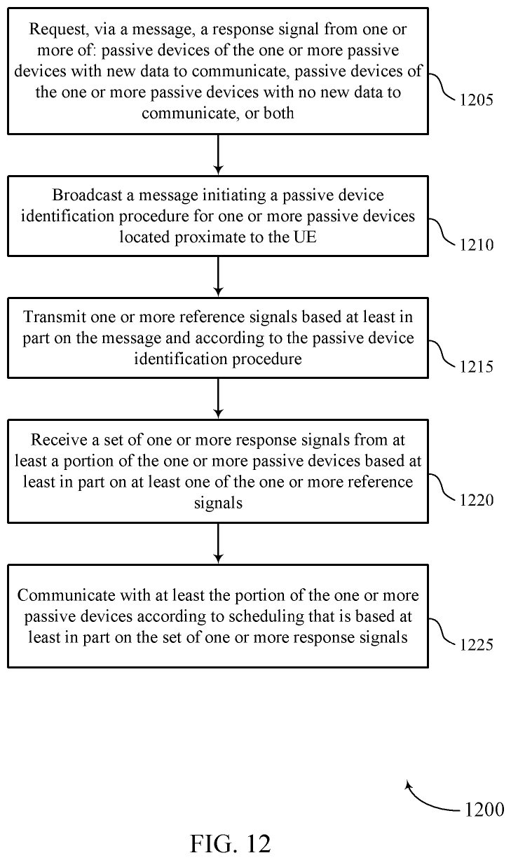

FIG. 12 shows a flowchart illustrating a method 1200 that supports detecting passive devices proximate to a reader device in accordance with one or more aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1205, the method may include requesting, via a message, a response signal from one or more of: passive devices of the one or more passive devices with new data to communicate, passive devices of the one or more passive devices with no new data to communicate, or both. The operations of 1205 may be performed in accordance with examples as disclosed herein. In some examples, aspects of the operations of 1205 may be performed by a broadcast manager 845 as described with reference to FIG. 8.

At 1210, the method may include broadcasting a message initiating a passive device identification procedure for one or more passive devices located proximate to the UE. The operations of 1210 may be performed in accordance with examples as disclosed herein. In some examples, aspects of the operations of 1210 may be performed by a procedure manager 825 as described with reference to FIG. 8.

At 1215, the method may include transmitting one or more reference signals based on the message and according to the passive device identification procedure. The operations of 1215 may be performed in accordance with examples as disclosed herein. In some examples, aspects of the operations of 1215 may be performed by a reference signal manager 830 as described with reference to FIG. 8.

At 1220, the method may include receiving a set of one or more response signals from at least a portion of the one or more passive devices based on at least one of the one or more reference signals. The operations of 1220 may be performed in accordance with examples as disclosed herein. In some examples, aspects of the operations of 1220 may be performed by a response signal manager 835 as described with reference to FIG. 8.

At 1225, the method may include communicating with at least the portion of the one or more passive devices according to scheduling that is based on the set of one or more response signals. The operations of 1225 may be performed in accordance with examples as disclosed herein. In some examples, aspects of the operations of 1225 may be performed by a scheduling manager 840 as described with reference to FIG. 8.

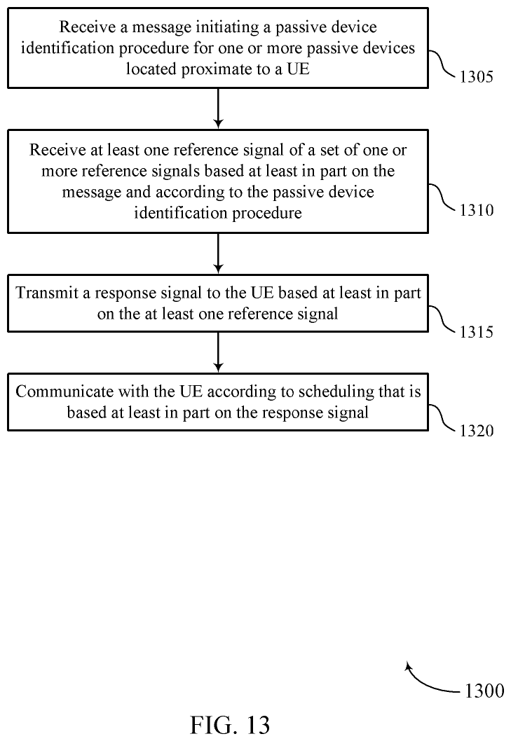

FIG. 13 shows a flowchart illustrating a method 1300 that supports detecting passive devices proximate to a reader device in accordance with one or more aspects of the present disclosure. The operations of the method 1300 may be implemented by a UE or its components as described herein. For example, the operations of the method 1300 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1305, the method may include receiving a message initiating a passive device identification procedure for one or more passive devices located proximate to a UE. The operations of 1305 may be performed in accordance with examples as disclosed herein. In some examples, aspects of the operations of 1305 may be performed by a procedure manager 825 as described with reference to FIG. 8.

At 1310, the method may include receiving at least one reference signal of a set of one or more reference signals based on the message and according to the passive device identification procedure. The operations of 1310 may be performed in accordance with examples as disclosed herein. In some examples, aspects of the operations of 1310 may be performed by a reference signal manager 830 as described with reference to FIG. 8.

At 1315, the method may include transmitting a response signal to the UE based on the at least one reference signal. The operations of 1315 may be performed in accordance with examples as disclosed herein. In some examples, aspects of the operations of 1315 may be performed by a response signal manager 835 as described with reference to FIG. 8.

At 1320, the method may include communicating with the UE according to scheduling that is based on the response signal. The operations of 1320 may be performed in accordance with examples as disclosed herein. In some examples, aspects of the operations of 1320 may be performed by a scheduling manager 840 as described with reference to FIG. 8.

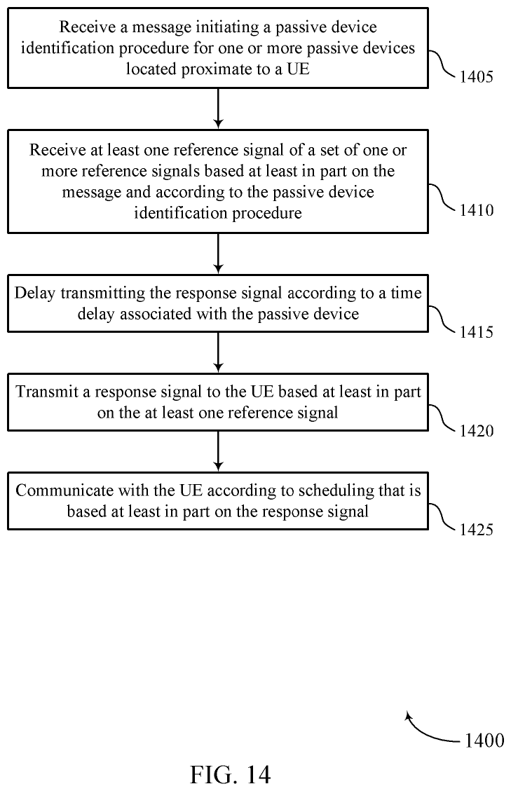

FIG. 14 shows a flowchart illustrating a method 1400 that supports detecting passive devices proximate to a reader device in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a message initiating a passive device identification procedure for one or more passive devices located proximate to a UE. The operations of 1405 may be performed in accordance with examples as disclosed herein. In some examples, aspects of the operations of 1405 may be performed by a procedure manager 825 as described with reference to FIG. 8.

At 1410, the method may include receiving at least one reference signal of a set of one or more reference signals based on the message and according to the passive device identification procedure. The operations of 1410 may be performed in accordance with examples as disclosed herein. In some examples, aspects of the operations of 1410 may be performed by a reference signal manager 830 as described with reference to FIG. 8.

At 1415, the method may include delaying transmitting the response signal according to a time delay associated with the passive device. The operations of 1415 may be performed in accordance with examples as disclosed herein. In some examples, aspects of the operations of 1415 may be performed by a device identification manager 855 as described with reference to FIG. 8.

At 1420, the method may include transmitting a response signal to the UE based on the at least one reference signal. The operations of 1420 may be performed in accordance with examples as disclosed herein. In some examples, aspects of the operations of 1420 may be performed by a response signal manager 835 as described with reference to FIG. 8.

At 1425, the method may include communicating with the UE according to scheduling that is based on the response signal. The operations of 1425 may be performed in accordance with examples as disclosed herein. In some examples, aspects of the operations of 1425 may be performed by a scheduling manager 840 as described with reference to FIG. 8.

The following provides an overview of aspects of the present disclosure:

Aspect 1: A method for wireless communication at a UE, comprising: broadcasting a message initiating a passive device identification procedure for one or more passive devices located proximate to the UE; transmitting one or more reference signals based at least in part on the message and according to the passive device identification procedure; receiving a set of one or more response signals from at least a portion of the one or more passive devices based at least in part on at least one of the one or more reference signals; and communicating with at least the portion of the one or more passive devices according to scheduling that is based at least in part on the set of one or more response signals.

Aspect 2: The method of aspect 1, wherein broadcasting the message comprises: selecting one or more resources associated with the one or more passive devices, wherein the message is broadcast on the one or more resources.

Aspect 3: The method of any of aspects 1 through 2, wherein broadcasting the message comprises: requesting, via the message, a response signal from one or more of: passive devices of the one or more passive devices with new data to communicate, passive devices of the one or more passive devices with no new data to communicate, or both.

Aspect 4: The method of any of aspects 1 through 3, wherein broadcasting the message comprises: including in the message an identifier associated with each of the one or more passive devices, wherein the set of one or more response signals are received based at least in part on the identifier indicated in the message.

Aspect 5: The method of any of aspects 1 through 4, further comprising: identifying a numerical quantity of passive devices located proximate to the UE based at least in part on a number of response signals in the set of one or more response signals.

Aspect 6: The method of aspect 5, further comprising: transmitting a signal to a network entity indicating the numerical quantity of passive devices located proximate to the UE.

Aspect 7: The method of aspect 6, further comprising: receiving a control signal scheduling a resource to use for the communicating, wherein the resource is based at least in part on the indication of the numerical quantity.

Aspect 8: The method of any of aspects 5 through 7, further comprising: selecting, based at least in part on the numerical quantity, resources from a set of available resources to use for the communicating; and scheduling the communications with at least the portion of the one or more passive devices using the resources.

Aspect 9: The method of any of aspects 1 through 8, further comprising: identifying, for each response signal in the set of one or more response signals, a time delay for the response signal; and identifying each passive device in at least the portion of the one or more passive devices based at least in part on the time delay of the response signal.

Aspect 10: The method of any of aspects 1 through 9, further comprising: identifying, for each response signal in the set of one or more response signals, a sequence indicated in the response signal; and identifying each passive device in at least the portion of the one or more passive devices based at least in part on the sequence indicated in the response signal.

Aspect 11: The method of any of aspects 1 through 10, further comprising: identifying, for each response signal in the set of one or more response signals, a TPRI indicated in the response signal; and identifying each passive device in at least the portion of the one or more passive devices based at least in part on the TPRI indicated in the response signal.

Aspect 12: The method of any of aspects 1 through 11, further comprising: identifying each passive device in at least the portion of the one or more passive devices based at least in part on a frequency shift of each response signal in the set of one or more response signals.

Aspect 13: The method of any of aspects 1 through 12, further comprising: identifying each passive device in at least the portion of the one or more passive devices based at least in part on a modulation rate of each response signal in the set of one or more response signals.

Aspect 14: The method of any of aspects 1 through 13, further comprising: identifying each passive device in at least the portion of the one or more passive devices based at least in part on a power domain randomization of each response signal in the set of one or more response signals.

Aspect 15: The method of any of aspects 1 through 14, wherein the one or more passive devices comprise at least one of a proximate UE, an IoT device, a passive RFID device, a semi-active RFID device, a device supporting backscattering-based communications, or a combination thereof.

Aspect 16: A method for wireless communication at a passive device, comprising: receiving a message initiating a passive device identification procedure for one or more passive devices located proximate to a UE; receiving at least one reference signal of a set of one or more reference signals based at least in part on the message and according to the passive device identification procedure; transmitting a response signal to the UE based at least in part on the at least one reference signal; and communicating with the UE according to scheduling that is based at least in part on the response signal.

Aspect 17: The method of aspect 16, further comprising: determining that the message was received on a resource associated with the passive device.

Aspect 18: The method of any of aspects 16 through 17, further comprising: determining that the message requests a response signal from one or more of: one or more passive devices with new data to communication, one or more passive devices with no new data to communicate, or both.

Aspect 19: The method of any of aspects 16 through 18, further comprising: delaying transmitting the response signal according to a time delay associated with the passive device.

Aspect 20: The method of any of aspects 16 through 19, further comprising: including a sequence associated with the passive device in the response signal.

Aspect 21: The method of any of aspects 16 through 20, further comprising: including a TPRI associated with the passive device in the response signal.

Aspect 22: The method of any of aspects 16 through 21, further comprising: applying a frequency shift associated with the passive device for the response signal.

Aspect 23: The method of any of aspects 16 through 22, further comprising: applying a modulation rate associated with the passive device for the response signal.

Aspect 24: The method of any of aspects 16 through 23, further comprising: applying a power domain randomization associated with the passive device for the response signal.

Aspect 25: An apparatus for wireless communication at a UE, comprising a processor; memory coupled with the processor; and instructions stored in the memory and executable by the processor to cause the apparatus to perform a method of any of aspects 1 through 15.

Aspect 26: An apparatus for wireless communication at a UE, comprising at least one means for performing a method of any of aspects 1 through 15.

Aspect 27: A non-transitory computer-readable medium storing code for wireless communication at a UE, the code comprising instructions executable by a processor to perform a method of any of aspects 1 through 15.

Aspect 28: An apparatus for wireless communication at a passive device, comprising a processor; memory coupled with the processor; and instructions stored in the memory and executable by the processor to cause the apparatus to perform a method of any of aspects 16 through 24.

Aspect 29: An apparatus for wireless communication at a passive device, comprising at least one means for performing a method of any of aspects 16 through 24.

Aspect 30: A non-transitory computer-readable medium storing code for wireless communication at a passive device, the code comprising instructions executable by a processor to perform a method of any of aspects 16 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, including further systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, etc., whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a variety of actions and, therefore, “determining” can include calculating, computing, processing, deriving, investigating, looking up (such as via looking up in a table, a database or another data structure), or ascertaining. Also, “determining” can include receiving (such as receiving information), or accessing (such as accessing data in a memory). Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
broadcasting a message initiating a passive device identification procedure for one or more passive devices located proximate to the UE;
transmitting one or more reference signals based at least in part on the message and according to the passive device identification procedure;
receiving a set of one or more response signals from at least a portion of the one or more passive devices based at least in part on at least one of the one or more reference signals; and
communicating with at least the portion of the one or more passive devices according to scheduling that is based at least in part on the set of one or more response signals.

2. The method of claim 1, wherein broadcasting the message comprises:
selecting one or more resources associated with the one or more passive devices, wherein the message is broadcast on the one or more resources.

3. The method of claim 1, wherein broadcasting the message comprises:
requesting, via the message, a response signal from one or more of: passive devices of the one or more passive devices with new data to communicate, passive devices of the one or more passive devices with no new data to communicate, or both.

4. The method of claim 1, wherein broadcasting the message comprises:
including in the message an identifier associated with each of the one or more passive devices, wherein the set of one or more response signals are received based at least in part on the identifier indicated in the message.

5. The method of claim 1, further comprising:
identifying a numerical quantity of passive devices located proximate to the UE based at least in part on a number of response signals in the set of one or more response signals.

6. A method for wireless communication at a passive device, comprising:
receiving a message initiating a passive device identification procedure for one or more passive devices located proximate to a user equipment (UE);
receiving at least one reference signal of a set of one or more reference signals based at least in part on the message and according to the passive device identification procedure;
transmitting a response signal to the UE based at least in part on the at least one reference signal; and
communicating with the UE according to scheduling that is based at least in part on the response signal.

7. An apparatus for wireless communication at a user equipment (UE), comprising:
at least one processor; and
memory coupled with the at least one processor, the memory storing instructions executable by the at least one processor to cause the UE to:
broadcast a message initiating a passive device identification procedure for one or more passive devices located proximate to the UE;
transmit one or more reference signals based at least in part on the message and according to the passive device identification procedure;
receive a set of one or more response signals from at least a portion of the one or more passive devices based at least in part on at least one of the one or more reference signals; and
communicate with at least the portion of the one or more passive devices according to scheduling that is based at least in part on the set of one or more response signals.

8. The apparatus of claim 7, wherein the instructions to broadcast the message are executable by the at least one processor to cause the UE to:
select one or more resources associated with the one or more passive devices, wherein the message is broadcast on the one or more resources.

9. The apparatus of claim 7, wherein the instructions to broadcast the message are executable by the at least one processor to cause the UE to:
request, via the message, a response signal from one or more of: passive devices of the one or more passive devices with new data to communicate, passive devices of the one or more passive devices with no new data to communicate, or both.

10. The apparatus of claim 7, wherein the instructions to broadcast the message are executable by the at least one processor to cause the UE to:
include in the message an identifier associated with each of the one or more passive devices, wherein the set of one or more response signals are received based at least in part on the identifier indicated in the message.

11. The apparatus of claim 7, wherein the instructions are further executable by the at least one processor to cause the UE to:
identify a numerical quantity of passive devices located proximate to the UE based at least in part on a number of response signals in the set of one or more response signals.

12. The apparatus of claim 11, wherein the instructions are further executable by the at least one processor to cause the UE to:
transmit a signal to a network entity indicating the numerical quantity of passive devices located proximate to the UE.

13. The apparatus of claim 12, wherein the instructions are further executable by the at least one processor to cause the UE to:
receive a control signal scheduling a resource to use for the communicating, wherein the resource is based at least in part on the indication of the numerical quantity.

14. The apparatus of claim 11, wherein the instructions are further executable by the at least one processor to cause the UE to:
select, based at least in part on the numerical quantity, resources from a set of available resources to use for the communicating; and
schedule the communications with at least the portion of the one or more passive devices using the resources.

15. The apparatus of claim 7, wherein the instructions are further executable by the at least one processor to cause the UE to:
identify, for each response signal in the set of one or more response signals, a time delay for the response signal; and
identify each passive device in at least the portion of the one or more passive devices based at least in part on the time delay of the response signal.

16. The apparatus of claim 7, wherein the instructions are further executable by the at least one processor to cause the UE to:
identify, for each response signal in the set of one or more response signals, a sequence indicated in the response signal; and
identify each passive device in at least the portion of the one or more passive devices based at least in part on the sequence indicated in the response signal.

17. The apparatus of claim 7, wherein the instructions are further executable by the at least one processor to cause the UE to:
identify, for each response signal in the set of one or more response signals, a backscattering pulse repetition interval time (TPRI) indicated in the response signal; and
identify each passive device in at least the portion of the one or more passive devices based at least in part on the TPRI indicated in the response signal.

18. The apparatus of claim 7, wherein the instructions are further executable by the at least one processor to cause the UE to:
identify each passive device in at least the portion of the one or more passive devices based at least in part on a frequency shift of each response signal in the set of one or more response signals.

19. The apparatus of claim 7, wherein the instructions are further executable by the at least one processor to cause the UE to:
identify each passive device in at least the portion of the one or more passive devices based at least in part on a modulation rate of each response signal in the set of one or more response signals.

20. The apparatus of claim 7, wherein the instructions are further executable by the at least one processor to cause the UE to:
identify each passive device in at least the portion of the one or more passive devices based at least in part on a power domain randomization of each response signal in the set of one or more response signals.

21. The apparatus of claim 7, wherein the one or more passive devices comprise at least one of a proximate UE, an internet-of-thing (IoT) device, a passive radio frequency identifier (RFID) device, a semi-active RFID device, a device supporting backscattering-based communications, or a combination thereof.

22. An apparatus for wireless communication at a passive device, comprising:
at least one processor; and
memory coupled with the at least one processor, the memory storing instructions executable by the at least one processor to cause the passive device to:
receive a message initiating a passive device identification procedure for one or more passive devices located proximate to a user equipment (UE);
receive at least one reference signal of a set of one or more reference signals based at least in part on the message and according to the passive device identification procedure;
transmit a response signal to the UE based at least in part on the at least one reference signal; and
communicate with the UE according to scheduling that is based at least in part on the response signal.

23. The apparatus of claim 22, wherein the instructions are further executable by the at least one processor to cause the passive device to:
determine that the message was received on a resource associated with the passive device.

24. The apparatus of claim 22, wherein the instructions are further executable by the at least one processor to cause the passive device to:
determine that the message requests a response signal from one or more of: one or more passive devices with new data to communication, one or more passive devices with no new data to communicate, or both.

25. The apparatus of claim 22, wherein the instructions are further executable by the at least one processor to cause the passive device to:
delay transmitting the response signal according to a time delay associated with the passive device.

26. The apparatus of claim 22, wherein the instructions are further executable by the at least one processor to cause the passive device to:
include a sequence associated with the passive device in the response signal.

27. The apparatus of claim 22, wherein the instructions are further executable by the at least one processor to cause the passive device to:
include a backscattering pulse repetition interval time (TPRI) associated with the passive device in the response signal.

28. The apparatus of claim 22, wherein the instructions are further executable by the at least one processor to cause the passive device to:
apply a frequency shift associated with the passive device for the response signal.

29. The apparatus of claim 22, wherein the instructions are further executable by the at least one processor to cause the passive device to:
apply a modulation rate associated with the passive device for the response signal.

30. The apparatus of claim 22, wherein the instructions are further executable by the at least one processor to cause the passive device to:
apply a power domain randomization associated with the passive device for the response signal.
